(19) United States
(12) Patent Application Publication
(10) Pub. No.: US 2015/0277940 A1
(43) Pub. Date: Oct. 1, 2015

(54) PROGRAM SETTING DEVICE AND PROGRAM SETTING METHOD

(71) Applicant: NEC CORPORATION, Minato-ku, Tokyo (JP)

(72) Inventor: Kenji Soejima, Tokyo (JP)

(73) Assignee: NEC Corporation, Minato-ku, Tokyo (JP)

(21) Appl. No.: 14/441,679

(22) PCT Filed: Nov. 14, 2013
(86) PCT No.: PCT/JP2013/006690

§ 371 Date: May 8, 2015

(30) Foreign Application Priority Data
Nov. 19, 2012 (JP) 2012-253443

(51) Int. Cl. G06F 9/445; G06F 9/54

(52) U.S. Cl. CPC G06F 9/44505; G06F 9/54

(57) ABSTRACT

A program setting device to allow setting items of a program to be flexibly defined in accordance with a level of skill of a user is provided.

A program setting device (100) includes a concretization logic execution unit (121) and a set value determination unit (120). The concretization logic execution unit (121) executes a concretization logic (311) for calculating a concrete setting item (302) which is a setting item specific to each of a plurality of implementations of a program from an abstract setting item (202) which is a setting item common to the plurality of implementations of the program. The set value determination unit (120), when a value of the abstract setting item (202) is input, causes the concretization logic execution unit (121) to calculate a value of the concrete setting item (302) relating to an implementation to be set from an input value of the abstract setting item (202) by using the concretization logic (311) for the implementation to be set, and determines the calculated value as a set value (306) of the concrete setting item (302).

### TECHNICAL FIELD

The present invention relates to a program setting device and a program setting method and, in particular, to a program setting device and a program setting method for making setting items of programs such as middleware and application programs.

### BACKGROUND ART

Standardization has been carried out in various technical fields and software (programs) that provides the same functionality is being made available as various implementations such as products and OSS (Open Source Software). As a result, engineers who use such software to construct systems need to understand different setting methods for different implementations of software.

Under these circumstances, processes for software engineers to learn a wide variety of implementations mentioned above such as certification systems have been provided. However, it has become difficult for such processes to keep up with the pace of recent development of technologies.

To solve the problem, approaches to hiding detailed setting items of implementations of software from users and presenting abstracted setting items to the users have been proposed.

For example, PTL1 discloses a technique for construction of object-oriented applications in which setting items for components are combined, abstracted and provided to a user while hiding detailed settings for the components from the user.

### CITATION LIST

### Patent Literature

[PTL1] Japanese Patent Application Laid-Open No. H09-120357

### SUMMARY OF INVENTION

### Technical Problem

In the method described in PTL1, settings for a set of a plurality of components that make up a system are combined into a set of setting items, a “granulation line”, for example, and the set of setting items is presented to a user. By defining names of setting items of the “granulation line” that are easily understandable to the user and hiding some of the setting items of components from the user, the amount of things for the user to learn is reduced. In addition, associations between the setting items for the “granulation line” and the setting items of the components are managed in order to reflect user-input values of setting items of the “granulation line” in the setting items of the components. In other words, mapping between abstract setting items (the setting items of the “granulation line”) and the setting items of the components is managed.

The method described in PTL1 can increase the ease of setting to some extent by providing abstract setting items to hide detailed setting items of the components from the user. However, the method described in PTL1 has a problem that abstract setting items cannot flexibly be defined (designed). This is because the abstract setting items are reflected in the setting items of components on the basis of the mapping as described above in the method of PTL1 and therefore user-input values of the abstract setting items are directly used as values of setting items for their corresponding components. Accordingly, it is impossible to flexibly define abstract setting items in accordance with a level of skill of the user, such as allowing the user to input a “production volume” from a menu consisting of “Large”, “Medium” and “Small”, for example.

An object of the present invention is to provide a program setting device and a program setting method that solve the above-described problem that setting items of programs cannot flexibly be defined in accordance with a level of skill of a user.

### Solution to Problem

A program setting device according to an exemplary aspect of the invention includes: a concretization logic execution means for executing a concretization logic for calculating a concrete setting item which is a setting item specific to each of a plurality of implementations of a program from an abstract setting item which is a setting item common to the plurality of implementations of the program, the concretization logic being defined for each of the plurality of implementations; and a set value determination means for, when a value of the abstract setting item is input, causing the concretization logic execution means to calculate a value of the concrete setting item relating to an implementation to be set from an input value of the abstract setting item by using the concretization logic for the implementation to be set, and determining the calculated value as a set value of the concrete setting item.

A program setting method according to an exemplary aspect of the invention includes: when a value of an abstract setting item which is a setting item common to a plurality of implementations of a program is input, calculating, by using a concretization logic for an implementation to be set out of concretization logics for calculating a concrete setting item which is a setting item specific to each of the plurality of implementations of the program from the abstract setting item, a value of the concrete setting item relating to the implementation to be set from an input value of the abstract setting item, the concretization logic being defined for each of the plurality of implementations; and determining the calculated value as a set value of the concrete setting item.

A computer readable storage medium according to an exemplary aspect of the invention records thereon a program causing a computer to perform a method including: when a value of an abstract setting item which is a setting item common to a plurality of implementations of a program is input, calculating, by using a concretization logic for an implementation to be set out of concretization logics for calculating a concrete setting item which is a setting item specific to each of the plurality of implementations of the program from the abstract setting item, a value of the concrete setting item relating to the implementation to be set from an input value of the abstract setting item, the concretization logic being defined for each of the plurality of implementations; and determining the calculated value as a set value of the concrete setting item.

### Advantageous Effects of Invention

An advantageous effect of the present invention is allowing setting items of a program to be flexibly defined in accordance with a level of skill of a user.

### BRIEF DESCRIPTION OF DRAWINGS

FIG. 1 is a block diagram illustrating a characteristic configuration of a first exemplary embodiment of the present invention.

FIG. 2 is a block diagram illustrating a configuration of a program setting device 100 according to the first exemplary embodiment of the present invention.

FIG. 3 is a flowchart illustrating an overall process performed by the program setting device 100 according to the first exemplary embodiment of the present invention.

FIG. 4 is a flowchart illustrating a set value determination process performed by the program setting device 100 according to the first exemplary embodiment of the present invention.

FIG. 5 is a flowchart illustrating an abstract set value determination process performed by the program setting device 100 according to the first exemplary embodiment of the present invention.

FIG. 6 is a flowchart illustrating a concretization process performed by the program setting device 100 according to the first exemplary embodiment of the present invention.

FIG. 7 is a flowchart illustrating a concrete set value determination process performed by the program setting device 100 according to the first exemplary embodiment of the present invention.

FIG. 8 is a diagram illustrating an example of entity information 131 according to the first exemplary embodiment of the present invention.

FIG. 9 is a diagram illustrating an example of a user interface screen 111 according to the first exemplary embodiment of the present invention.

FIG. 10 is a diagram illustrating another example of a user interface screen 111 according to the first exemplary embodiment of the present invention.

FIG. 11 is a diagram illustrating another example of a user interface screen 111 according to the first exemplary embodiment of the present invention.

FIG. 12 is a diagram illustrating another example of a user interface screen 111 according to the first exemplary embodiment of the present invention.

FIG. 13 is a flowchart illustrating a set value determination process performed by a program setting device 100 according to a second exemplary embodiment of the present invention.

FIG. 14 is a diagram illustrating an example of entity information 131 according to the second exemplary embodiment of the present invention.

FIG. 15 is a diagram illustrating an example of a user interface screen 111 according to the second exemplary embodiment of the present invention.

FIG. 16 is a diagram illustrating another example of a user interface screen 111 according to the second exemplary embodiment of the present invention.

FIG. 17 is a diagram illustrating another example of a user interface screen 111 according to the second exemplary embodiment of the present invention.

### DESCRIPTION OF EMBODIMENTS

### First Exemplary Embodiment

A first exemplary embodiment of the present invention will be described first.

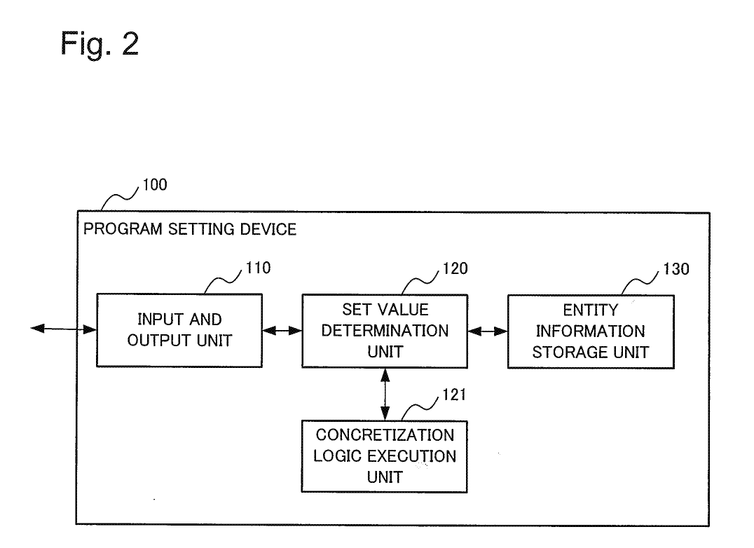

A configuration of the first exemplary embodiment of the present invention will be described first. FIG. 2 is a block diagram illustrating a configuration of a program setting device 100 according to the first exemplary embodiment of the present invention.

Referring to FIG. 2, the program setting device 100 of the first exemplary embodiment of the present invention includes an input and output unit 110, a set value determination unit 120, a concretization logic execution unit 121, and an entity information storage unit 130.

The entity information storage unit 130 stores one or more pieces of entity information 131. The entity information 131 represents a data model relating to setting items of software (program) that provides certain functionality, such as an application server (AP server) or a database server (DB server), for example.

Consider that a setting item is the amount of memory of an AP server, for example, then the amount of memory used for operation and monitoring of the AP server varies among implementations of the same AP server. Accordingly, the amount of memory of the AP server that depends on the implementations needs to be set.

Therefore, in the first exemplary embodiment of the present invention, setting items that are determined by specifications or the like of software that provides certain functionality, do not depend on implementations, and are common to the implementations are defined as abstract setting items 202 of the software, and setting items that depend on the implementations and are set for each implementation are defined as concrete setting items 302. Values of the concrete setting items 302 are calculated from values of the abstract setting items 202 using a concretization logic 311, which will be described later.

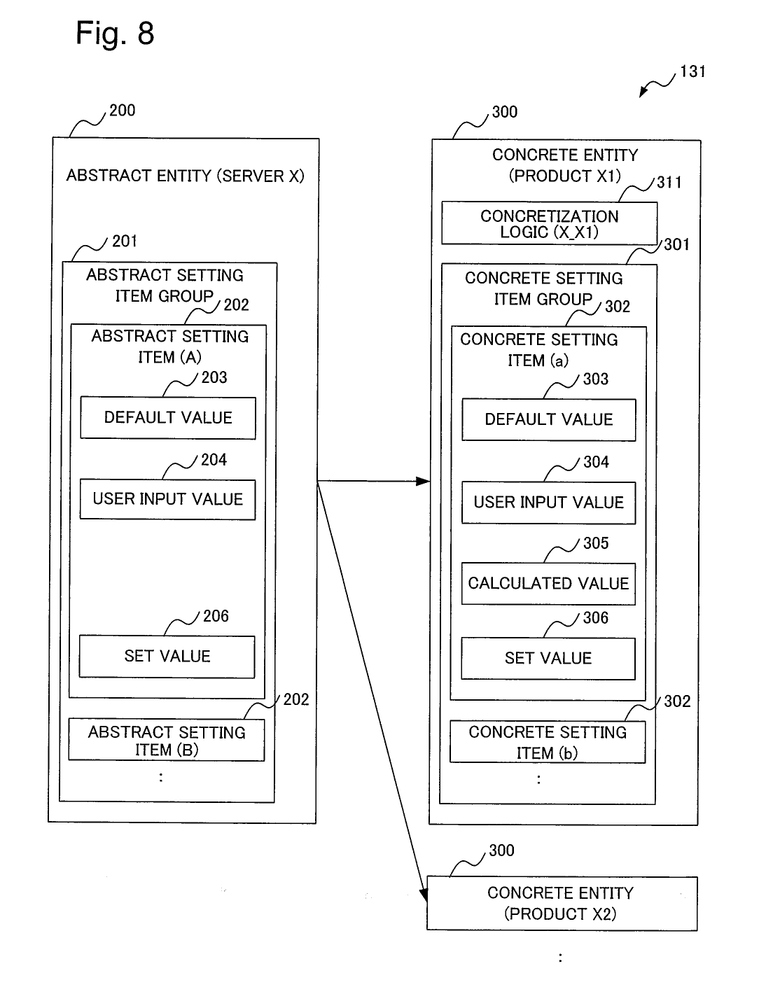

FIG. 8 is a diagram illustrating an example of entity information 131 according to the first exemplary embodiment of the present invention. Referring to FIG. 8, the entity information 131 includes an abstract entity 200 and one or more concrete entities 300.

The arrows between the abstract entity 200 and the concrete entities 300 represent that the abstract entity 200 and the concrete entities 300 are in a relationship in which values of the concrete setting items 302 of the concrete entities 300 are calculated from the abstract setting items 202 of the abstract entity 200. In exemplary embodiments of the present invention, a concrete entity 300 in such a relation is referred to as an entity concretized from an abstract entity 200 and a concrete setting item 302 is referred to as a setting item concretized from an abstract setting item 202.

The abstract entity 200 represents software that provides certain functionality, such as an AP server or a DB server, as noted above. The concrete entities 300 represent different implementations of software that provide the same functionality, such as products of an AP server or products of a DB server.

The abstract entity 200 includes an abstract setting item group 201. The abstract setting item group 201 includes one or more abstract setting items 202 such as the amount of memory, the number of threads, and a timeout value. Each abstract setting item 202 includes a default value 203, a user input value 204 and a set value 206. The default value 203 is a value of the abstract setting item 202 that is used when a user input value 204 is not set. The default value 203 is set beforehand by a person such as an administrator. The user input value 204 is a value of the abstract setting item 202 that is input by a user. In the initial state, “no value (null)” is set as the user input value 204. The set value 206 is a value determined as the set value of the abstract setting item 202.

Each concrete entity 300 includes a concrete setting item group 301. The concrete setting item group 301 includes one or more concrete setting items 302 such as the amount of memory, the number of threads and a timeout value. Each concrete setting item 302 includes a default value 303, a user input value 304, a calculated value 305 and a set value 306. The default value 303 is a value of the concrete setting item 302 that is used when no values are set as the user input value 304 and the calculated value 305. The default value 303 is set beforehand by a person such as an administrator. The user input value 304 is a value of the concrete setting item 302 that is input by a user. The calculated value 305 is a value calculated from the set value 206 of the abstract setting item 202 using a concretization logic 311, which will be described later. In the initial state, “no value (null)” is set as the user input value 304 and the calculated value 305. The set value 306 is a value determined as the set value of the concrete setting item 302. The set value 306 is used for configuring an implementation corresponding to the concrete entity 300.

Each concrete entity 300 further includes a concretization logic 311. The concretization logic 311 is a calculation logic for calculating a value of the concrete setting item 302 from an abstract setting item 202. The concretization logic 311 is defined for a pair of the abstract entity 200 and a concrete entity 300. A logic for calculating a value of each concrete setting item 302 is defined in the concretization logic 311.

The concretization logic 311 corrects a value of an abstract setting item 202 in accordance with an implementation corresponding to the concrete entity 300 to calculate a value of a concrete setting item 302. For example, the concretization logic 311 multiplies the value of the amount of memory that is an abstract setting item 202 by a predetermined factor or adds a predetermined value to the value of the amount of memory in accordance with the implementation to calculate the amount of memory that is the concrete setting item 302.

Note that the concretization logic 311 may calculate a value of one concrete setting item 302 from a plurality of abstract setting items 202. For example, the concretization logic 311 may perform a predetermined calculation according to the implementation on the amount of memory and the number of thread that are abstract setting items 202 to calculate the amount of memory that is a concrete setting item 302.

Furthermore, the concretization logic 311 may calculate a value of a concrete setting item 302 from a level set in an abstract setting item 202. For example, if a value of an abstract setting item 202 is defined with a level such as “large”, “medium” or “small”, the concretization logic 311 may calculate a value for each level according to the implementation.

The concretization logic 311 is defined by the developer of the implementation (product), for example, and is set beforehand by a person such as an administrator.

In the example in FIG. 8, the entity information 131 includes an abstract entity 200, “Server X”, and concrete entities 300, “Product X1” and “Product X2”, concretized from the abstract entity 200. The abstract entity 200 “Server X” includes abstract setting items 202, “A” and “B”. The concrete entity 300 “Product X1” includes concrete setting items 302, “a” and “b”. Furthermore, the concrete entity 300 “Product X1” includes a concretization logic 311, “X_X1”.

The input and output unit 110 inputs values of setting items from the user and outputs values of setting items to the user through input and output devices (not depicted) such as a mouse, a display, or a touch screen. The input and output unit 110 inputs and outputs values of setting items through user interface screens 111, which will be described later.

The set value determination unit 120 determines a set value 206 of each abstract setting item 202. The set value determination unit 120 inputs the set value 206 into the concretization logic execution unit 121 to cause the concretization logic execution unit 121 to calculate a value of a concrete setting item 302. Furthermore, the set value determination unit 120 determines a set value 306 of the concrete setting item 302.

The concretization logic execution unit 121 executes a concretization logic 311.

Note that the input and output unit 110, the set value determination unit 120 and the concretization logic execution unit 121 may be a computer that includes a CPU (Central Processing Unit) and a storage medium on which a program is stored and operates under the control of the program.

An operation of the program setting device 100 according to the first exemplary embodiment of the present invention will be described below.

### (Overall Process)

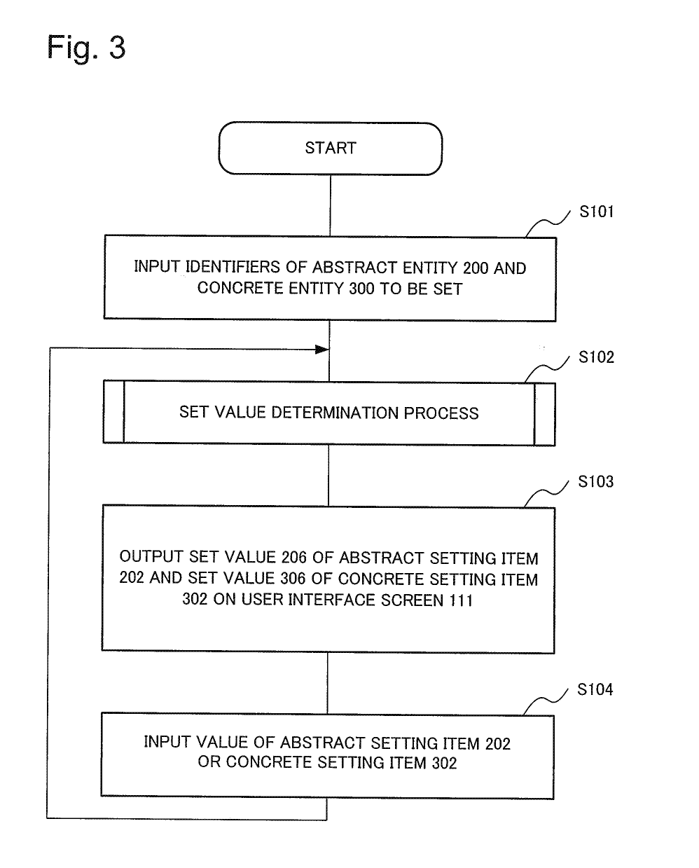

An overall process performed by the program setting device 100 according to the first exemplary embodiment of the present invention will be described first. FIG. 3 is a flowchart illustrating an overall process performed by the program setting device 100 according to the first exemplary embodiment of the present invention.

First, the input and output unit 110 accepts inputs of identifiers of an abstract entity 200 and a concrete entity 300 that are to be set from the user (step S101). The input and output unit 110 may output a list of abstract entities 200 and concrete entities 300 concretized from the abstract entities 200 to allow the user to select an abstract entity 200 and a concrete entity 300 that are to be set. Furthermore, the input and output unit 110 may display input fields for the identifiers to allow the user to directly input the identifiers.

The set value determination unit 120 performs a “set value determination process”, which will be described later, to determine a set value 206 of an abstract setting item 202 and a set value 306 of a concrete setting item 302 (step S102).

The input and output unit 110 outputs the set value 206 of the abstract setting item 202 and the set value 306 of the concrete setting item 302 on a user interface screen 111 (step S103).

The input and output unit 110 accepts an input of a value of the abstract setting item 202 or the concrete setting item 302 on the user interface screen 111 from the user (step S104).

Then steps S102 through S104 are repeated.

A user interface screen 111 according to the first exemplary embodiment of the present invention will now be described.

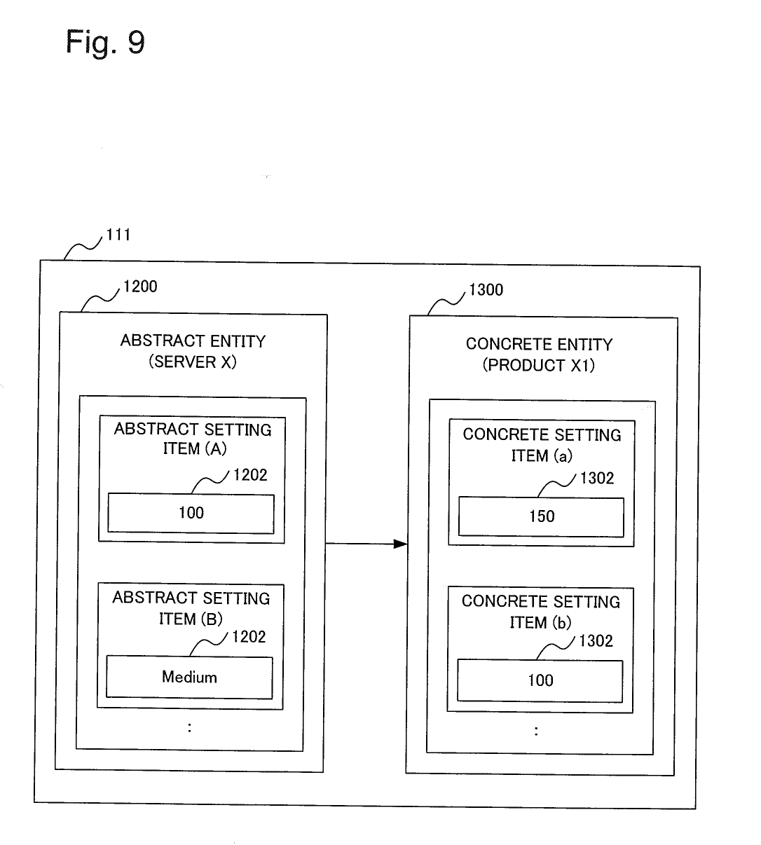

FIGS. 9, 10, 11 and 12 are diagrams illustrating examples of the user interface screen 111 according to the first exemplary embodiment of the present invention. The exemplary user interface screens 111 correspond to the entity information 131 in FIG. 8.

Referring to FIG. 9, an abstract entity display section 1200 indicating an abstract entity 200 and a concrete entity display section 1300 indicating a concrete entity 300 concretized from the abstract entity 200 are associated with each other and arranged on the user interface screen 111.

An input field 1202 for allowing a user to input a value of each abstract setting item 202 included in the abstract setting item group 201 is provided in the abstract entity display section 1200. The current set values 206 of the abstract setting items 202 are displayed in the input fields 1202. The values input in the input fields 1202 are set as the user input values 204 of the abstract setting items 202 by the set value determination unit 120. Similarly, an input field 1302 for allowing a user to input a value of each concrete setting item 302 included in the concrete setting item group 301 is provided in the concrete entity display section 1300. The current set values 306 of the concrete setting items 302 are displayed in the input fields 1302. The values input in the input fields 1302 are set as the user input values 304 of the concrete setting items 302 by the set value determination unit 120.

Note that the current set values 206 and 306 may be displayed separately from the input fields 1202 and 1302.

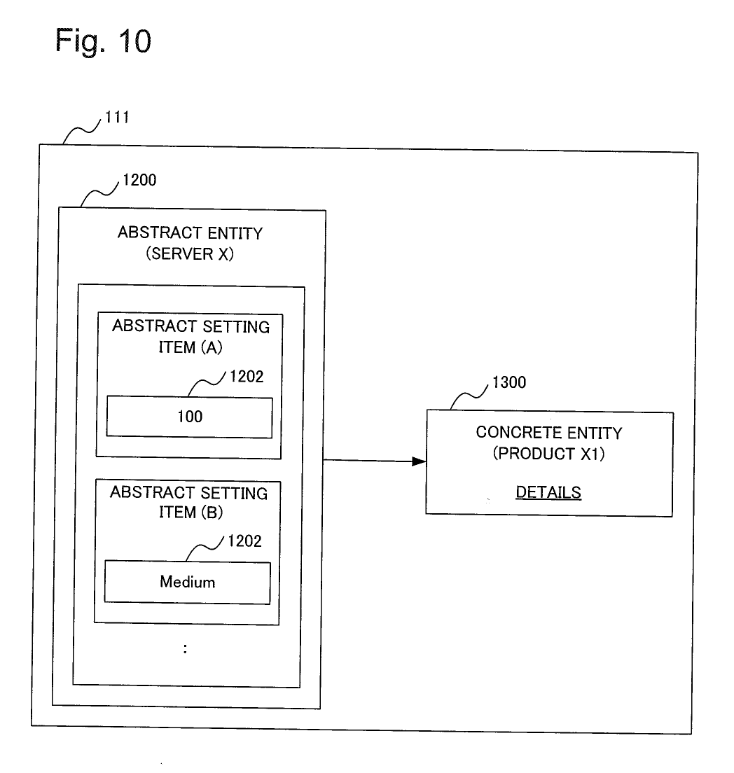

Furthermore, the input and output unit 110 may output a user interface screen 111 in which the concrete entity display section 1300 is hidden in the initial state as depicted in FIG. 10. In this case, when the user depresses a “Details” button or the like as necessary, the concrete entity display section 1300 is displayed as depicted in FIG. 9. In this way, the complexity of the concrete entity 300 can be hidden from the user and detailed information about the concrete entity 300 can be presented to the user in accordance with the skill of the user.

### (Set Value Determination Process)

A set value determination process performed by the program setting device 100 according to the first exemplary embodiment of the present invention will be described next.

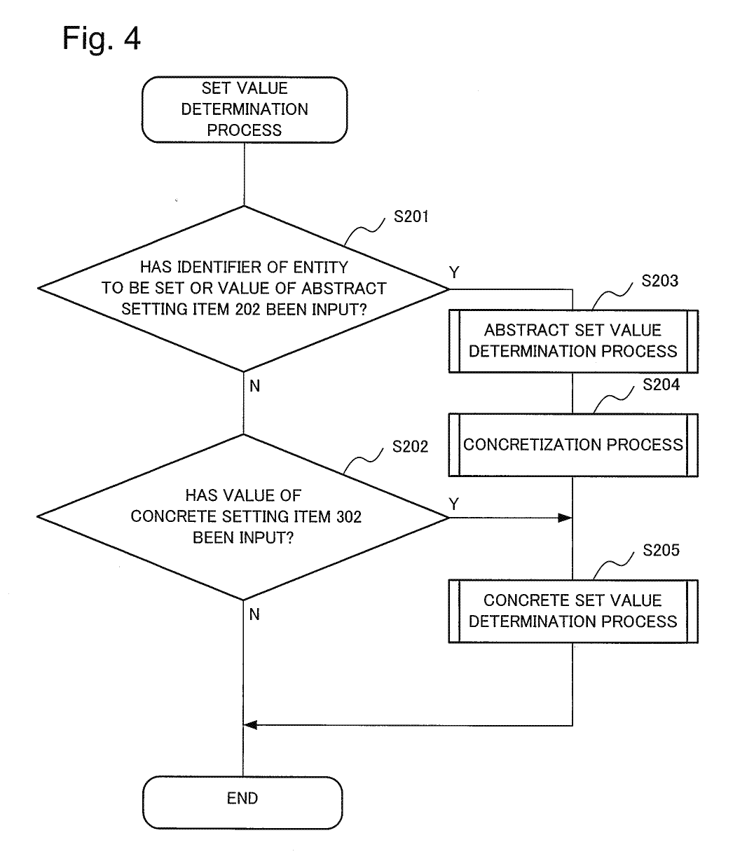

FIG. 4 is a flowchart illustrating a set value determination process performed by the program setting device 100 according to the first exemplary embodiment of the present invention.

When identifiers of entities to be set have been input at step S101 described above or when a value of an abstract setting item 202 has been input at step S104 (Y at step S201), the set value determination unit 120 executes an “abstract set value determination process”, which will be described later, to determine a set value 206 of each abstract setting item 202 (step S203). The set value determination unit 120 then inputs the set value 206 of each abstract setting item 202 into the concretization logic execution unit 121 and instruct the concretization logic execution unit 121 to execute a “concretization process” to calculate a calculated value 305 for the concrete entity 300 (step S204). The set value determination unit 120 further executes a “concrete set value determination process”, which will be described later, to determine a set value of each concrete setting item 302 (step S205).

When a value of the concrete setting item 302 has been input at step S104 described above (Y at step S202), the set value determination unit 120 executes step S205 to determine a set value 306 of the concrete setting item 302.

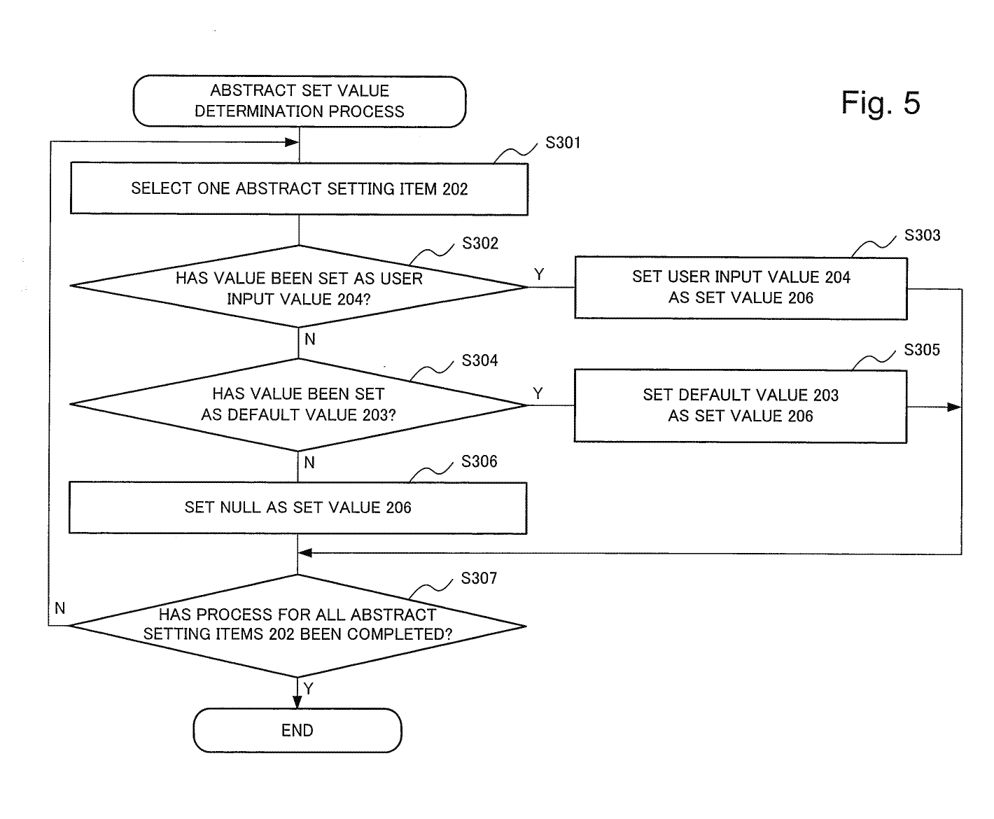

FIG. 5 is a flowchart illustrating an abstract set value determination process performed by the program setting device 100 according to the first exemplary embodiment of the present invention.

First, the set value determination unit 120 selects one abstract setting item 202 from the abstract setting item group 201 (step S301).

The set value determination unit 120 determines whether or not a value has been set as the user input value 204 of the selected abstract setting item 202 (step S302).

If a value has been set as the user input value 204 at step S302 (Y at step S302), the set value determination unit 120 determines the user input value 204 as the set value of the abstract setting item 202 and sets the value as the set value 206 (step S303).

If no value has been set as the user input value 204 at step S302 (N at step S302), the set value determination unit 120 determines whether or not a value has been set as the default value 203 (step S304).

If a value has been set as the default value 203 at step S304 (Y at step S304), the set value determination unit 120 determines the default value 203 as the set value of the abstract setting item 202 and sets the default value 203 as the set value 206 (step S305).

If no value has been set as the default value 203 at step S304 (N at step S304), the set value determination unit 120 sets “no value (null)” as the set value 206 (step S306).

The set value determination unit 120 repeats step S301 through step S306 for all abstract setting items 202 included in the abstract setting item group 201 (step S307).

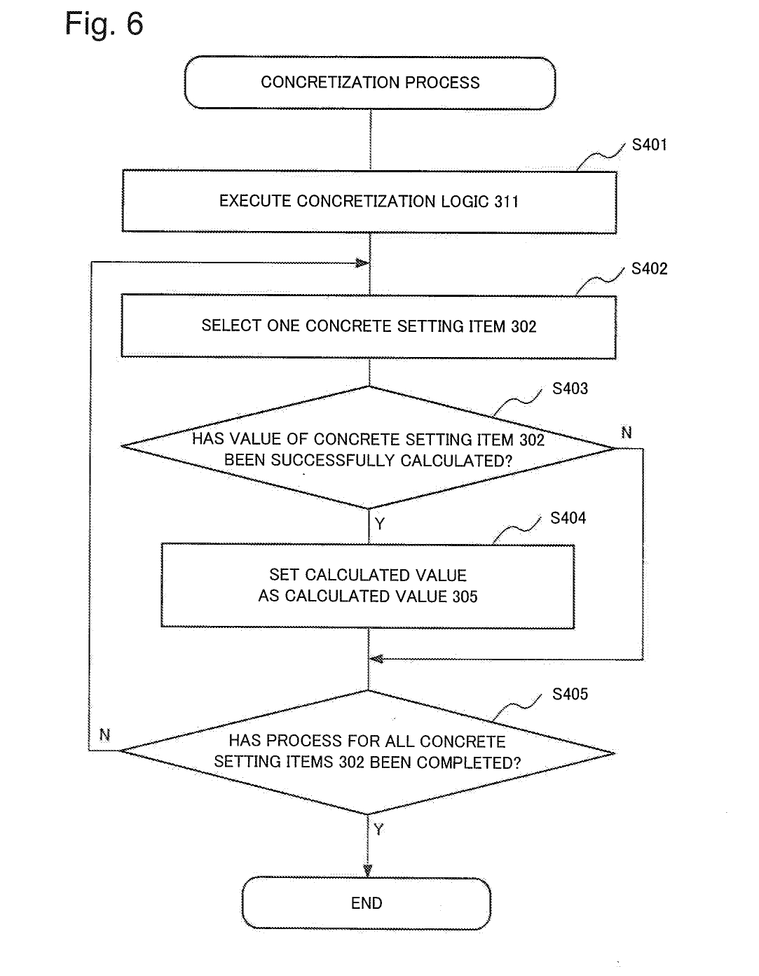

FIG. 6 is a flowchart illustrating a concretization process performed by the program setting device 100 according to the first exemplary embodiment of the present invention.

First, the concretization logic execution unit 121 executes a concretization logic 311 (step S401). The concretization logic 311 calculates a value of each concrete setting item 302 included in the concrete setting item group 301 from the set values 206 of the abstract setting items 202.

The concretization logic execution unit 121 selects one concrete setting item 302 from the concrete setting item group 301 (step S402).

The concretization logic execution unit 121 determines whether or not a value of the selected concrete setting item 302 has been successfully calculated (step S403). For example, if “no value (null)” is set as the set value 206 of the abstract setting item 202 that is required for the concretization logic 311 to calculate a value of the concrete setting item 302, the concretization logic 311 cannot calculate a value of the concrete setting item 302.

If a value of the concrete setting item 302 has been successfully calculated at step S403 (Y at step S403), the concretization logic execution unit 121 sets the calculated value as the calculated value 305 (step S404).

If a value of the concrete setting item 302 is not set at step S403 (N at step S403), “no value (null)” remains as the calculated value 305.

The concretization logic execution unit 121 repeats step S401 through step S404 for all concrete setting items 302 included in the concrete setting item group 301 (step S405).

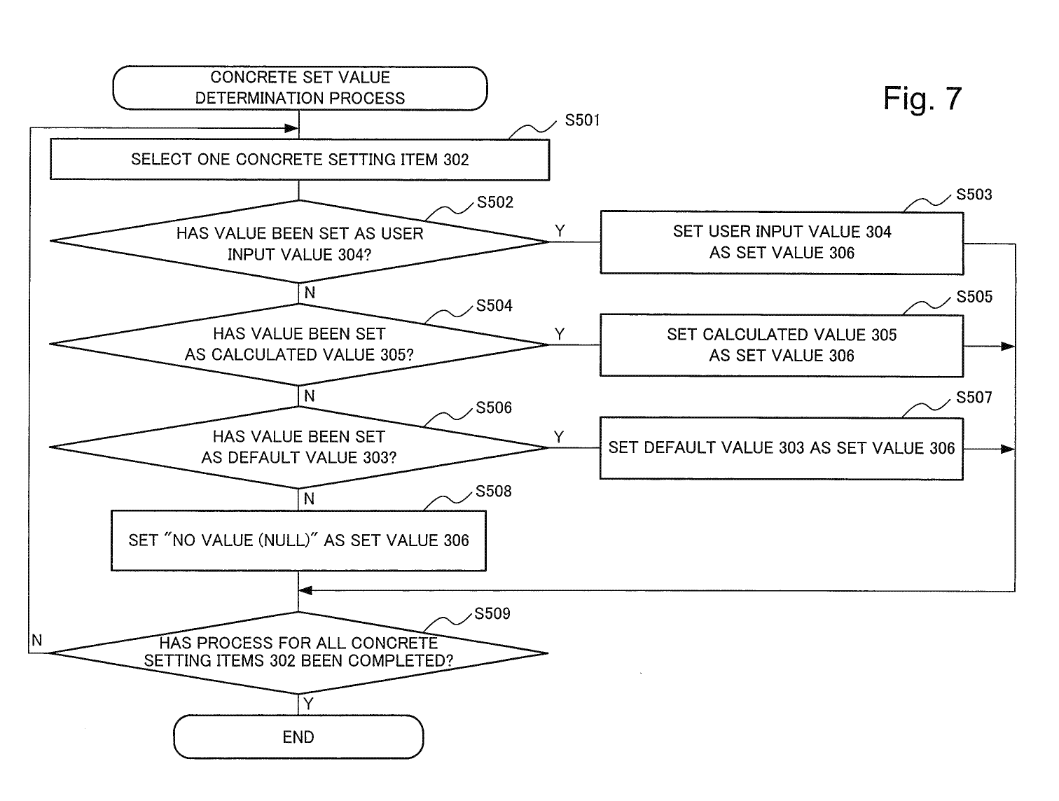

FIG. 7 is a flowchart illustrating a concrete set value determination process performed by the program setting device 100 according to the first exemplary embodiment of the present invention.

First, the set value determination unit 120 selects one concrete setting item 302 from the concrete setting item group 301 (step S501).

The set value determination unit 120 determines whether or not a value has been set as the user input value 304 of the selected concrete setting item 302 (step S502).

If a value has been set as the user input value 304 at step S502 (Y at step S502), the set value determination unit 120 determines the user input value 304 as the set value of the concrete setting item 302 and sets the value as the set value 306 (step S503).

If no value has been set as the user input value 304 at step S502 (N at step S502), the set value determination unit 120 determines whether or not a value has been set as the calculated value 305 (step S504).

If a value has been set as the calculated value 305 at step S504 (Y at step S504), the set value determination unit 120 determines the calculated value 305 as the set value of the concrete setting item 302 and sets the value as the set value 306 (step S505).

If no value has been set as the user input value 304 at step S504 (N at step S504), the set value determination unit 120 determines whether or not a value has been set as the default value 303 (step S506).

If a value has been set as the default value 303 at step S506 (Y at step S506), the set value determination unit 120 determines the default value 303 as the set value of the concrete setting item 302 and sets the value as the set value 306 (step S507).

If no value has been set as the default value 303 at step S506 (N at step S506), the set value determination unit 120 sets “no value (null)” as the set value 306 (step S508).

The set value determination unit 120 repeats step S501 through step S508 for all concrete setting items 302 included in the concrete setting item group 301 (step S509).

For example, assume that “100” is set as the default value 203 of the abstract setting item 202 “A” of the abstract entity 200 “Server X” in the entity information 131 in FIG. 8.

If the user inputs the identifier “Server X” of the abstract entity 200 and the identifier “Product X1” of the concrete entity 300 as the identifiers of the entities to be set, the set value determination unit 120 sets the default value 203 (“100”) as the set value 206 of the abstract setting item 202 “A” in the “abstract set value determination process”. Furthermore, the concretization logic execution unit 121 uses the concretization logic 311 “X_X1” to calculates a value, “150”, of the concrete setting item 302 “a” from the set value 206 and sets the value as the calculated value 305 in the “concretization process”. Then the set value determination unit 120 sets the calculated value 305 (“150”) as the set value 306 of the concrete setting item 302 “a” in the “concrete set value determination process”. In this case, the input and output unit 110 outputs a user interface screen 111 in which the set value 206 (“100”) is displayed in the input field 1202 of the abstract setting item 202 “A” and the set value 306 (“150”) is displayed in the input field 1302 of the concrete setting item 302 “a” as depicted in FIG. 9.

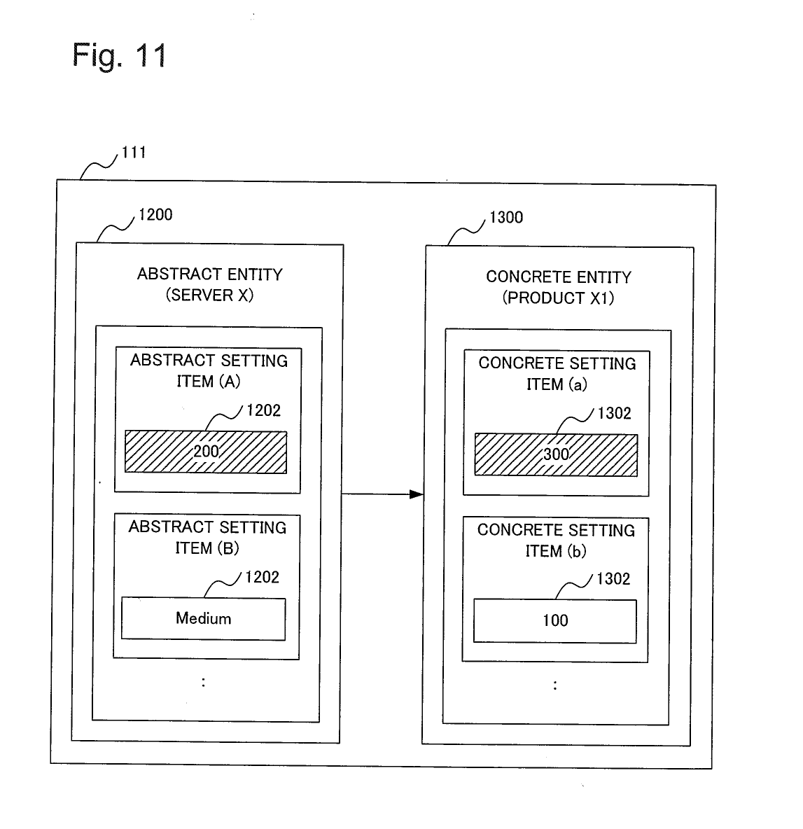

If the user inputs a value, “200”, in the input field 1202 of the abstract setting item 202 “A”, the set value determination unit 120 sets the user input value 204 (“200”) as the set value 206 of the abstract setting item 202 “A” in the “abstract set value determination process”. Furthermore, the concretization logic execution unit 121 uses the concretization logic 311 “X_X1” to calculate a value, “300”, of the concrete setting item 302 “a” from the set value 206 and sets the value as the calculated value 305 in the “concretization process”. Then the set value determination unit 120 sets the calculated value 305 (“300”) as the set value 306 of the concrete setting item 302 “a” in the “concrete set value determination process”. In this case, the input and output unit 110 outputs a user interface screen 111 in which the set value 206 (“200”) is displayed in the input field 1202 of the abstract setting item 202 “A” and the set value 306 (“300”) is displayed in the input field 1302 of the concrete setting item 302 “a” as depicted in FIG. 11.

Note that the input and output unit 110 may indicate, in the user interface screen 111, the updated (determined) abstract setting item 202 and concrete setting item 302 and their set values 206, 306 to the user by changing the colors of or otherwise highlighting the input fields 1202, 1302 of the abstract setting item 202 and the concrete setting item 302 for which the set values 206, 306 have been updated (determined) as illustrated in FIG. 11.

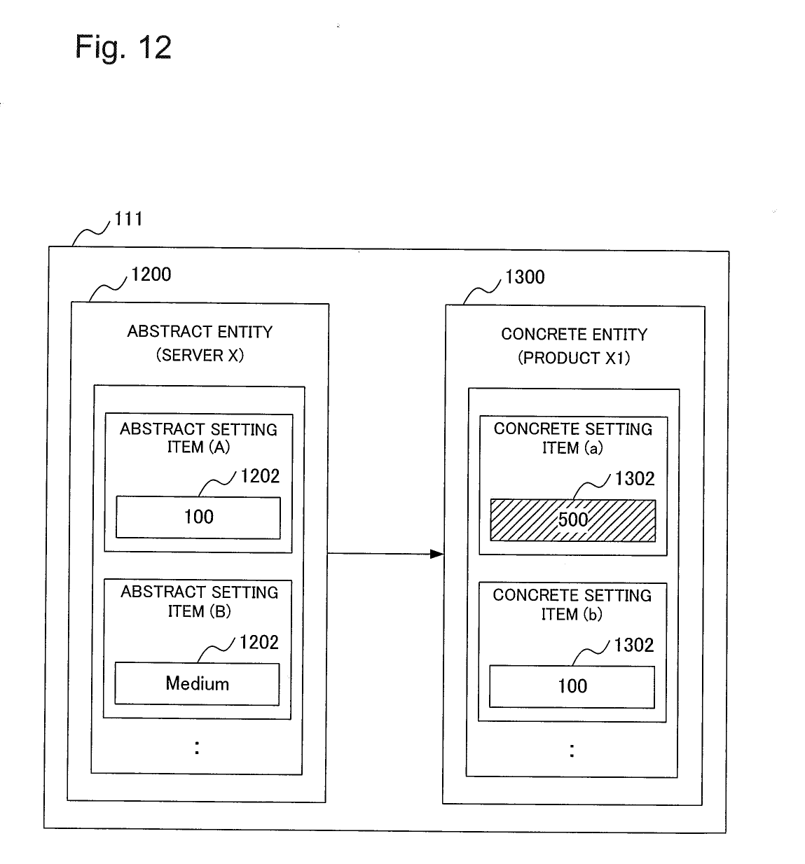

If the user inputs a value, “500”, in the input field 1302 of the concrete setting item 302 “a”, the set value determination unit 120 sets the user input value 304 (“500”) as the set value 306 of the concrete setting item 302 “a” in the “concrete set value determination process”. In this case, the input and output unit 110 outputs a user interface screen 111 in which the set value 306 (“500”) is displayed in the input field 1302 of the concrete setting item 302 “a” as depicted in FIG. 12.

With this, the operation of the first exemplary embodiment of the present invention is completed.

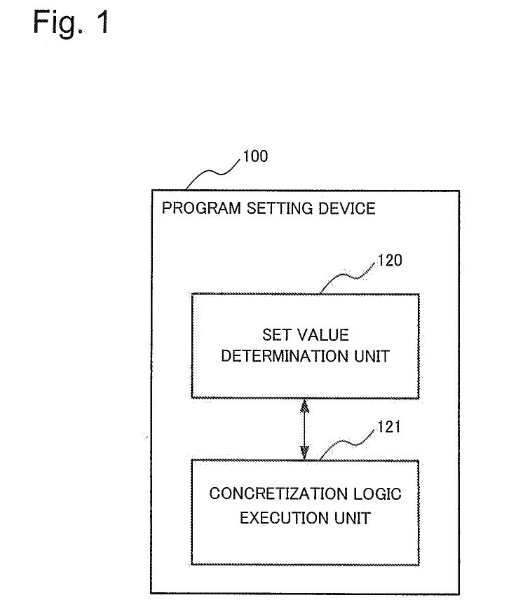

A characteristic configuration of the first exemplary embodiment of the present invention will be described next. FIG. 1 is a block diagram illustrating a characteristic configuration of the first exemplary embodiment of the present invention.

Referring to FIG. 1, a program setting device 100 includes a concretization logic execution unit 121 and a set value determination unit 120.

The concretization logic execution unit 121 executes a concretization logic 311 for calculating a concrete setting item 302 which is a setting item specific to each of a plurality of implementations of a program from an abstract setting item 202 which is a setting item common to the plurality of implementations of the program. The concretization logic 311 is defined for each of the plurality of implementations.

The set value determination unit 120, when a value of the abstract setting item 202 is input, causes the concretization logic execution unit 121 to calculate a value of the concrete setting item 302 relating to an implementation to be set from an input value of the abstract setting item 202 by using the concretization logic 311 for the implementation to be set, and determines the calculated value as a set value 306 of the concrete setting item 302.

According to the first exemplary embodiment of the present invention, setting items of a program (software) can be flexibly defined (designed) in accordance with a level of skill of a user. This is because abstract setting items 202 which are common to a plurality of implementations of the program, concrete setting items 302 which are specific to each of a plurality of implementations of the program, and a concretization logic 311 for calculating the complete setting items 302 from the absolute setting items 202 are defined, and the set value determination unit 120 causes the concretization logic execution unit 121 to use the concretization logic 311 for an implementation to be set to calculate the values of the concrete setting items 302 relating to the implementation to be set from input values of the abstract setting items 202. This enables setting items for each software program to be abstracted in accordance with the user's level of learning the software and requirements of a system using the software and enables a wide variety of setting interfaces to be provided. In addition, even a user at a low learning level can readily configure software and the user's learning cost is reduced.

With the method described in PTL1 described previously, even a user who understands detailed setting items of components that make up a system needs to make settings for the components through abstract setting items. In system development, situations, in which problems cannot be addressed by setting abstract setting items but need to be solved by directly setting values of setting items for each software implementation, occur frequently.

According to the first exemplary embodiment of the present invention, a user at a high learning-level who understands setting items for implementations of a program (software) can make detailed settings for the software. This is because when a value of a concrete setting item 302 is input, the set value determination unit 120 determines the input value of the concrete setting item 302 as the set value 306 of the concrete setting item 302 in priority to a calculated value of the concrete setting item 302.

### Second Exemplary Embodiment

A second exemplary embodiment of the present invention will be described next.

The second exemplary embodiment of the present invention differs from the first exemplary embodiment of the present invention in that a data model represented by entity information 131 further includes an intermediate abstract entity 250 between an abstract entity 200 and a concrete entity 300.

The second exemplary embodiment of the present invention has the same configuration as the first exemplary embodiment of the present invention (FIG. 2).

In the second exemplary embodiment of the present invention, a setting item that is common to a set made up of some of a plurality of implementations is defined as an intermediate abstract stetting item 252. A value of an intermediate abstract setting item 252 is calculated by a concretization logic 261 from a value of an abstract setting item 202. A value of a concrete setting item 302 is calculated by a concretization logic 311 from a value of an intermediate abstract setting item 252.

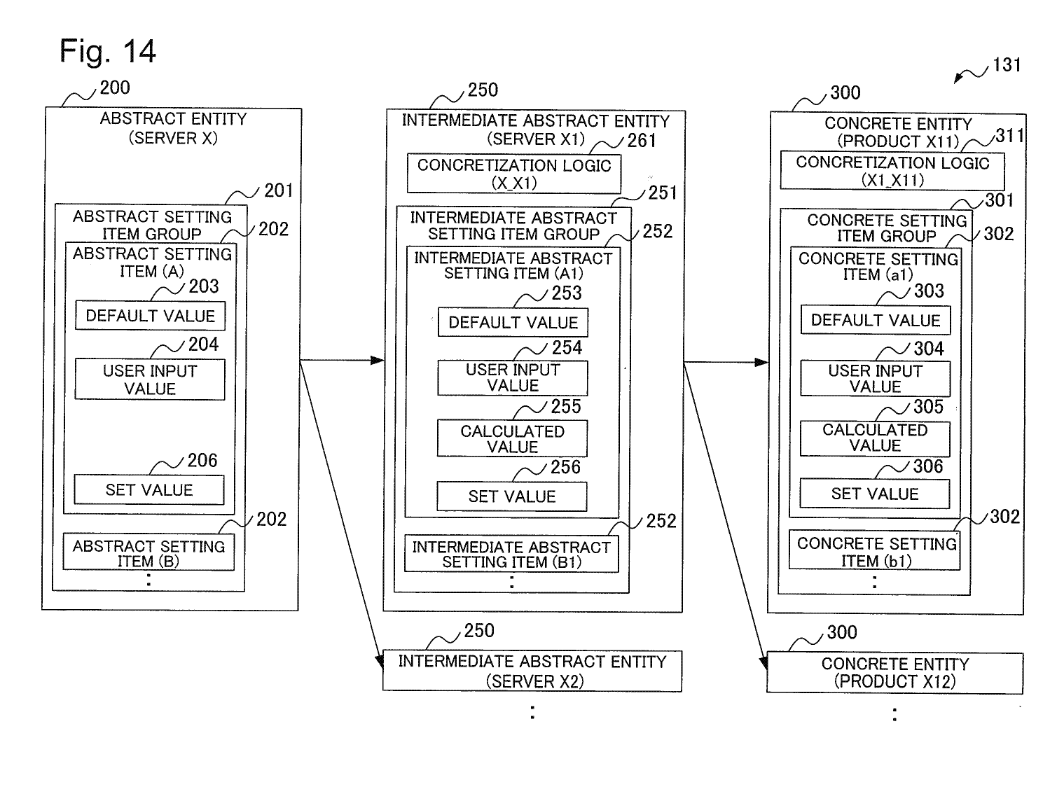

FIG. 14 is a diagram illustrating an example of entity information 131 according to the second exemplary embodiment of the present invention. Referring to FIG. 14, the entity information 131 includes an abstract entity 200, one or more intermediate abstract entities 250 concretized from the abstract entity 200, and one or more concrete entities 300 concretized from an intermediate abstract entity 250.

An intermediate abstract entity 250 includes an intermediate abstract setting item group 251. The intermediate abstract setting item group 251 includes one or more intermediate abstract setting items 252. Each intermediate abstract setting item 252 includes a default value 253, a user input value 254, a calculated value 255 and a set value 256.

Each intermediate abstract entity 250 further includes a concretization logic 261. The concretization logic 261 is a calculation logic for calculating a value of an intermediate abstract setting item 252 from a value of an abstract setting item 202.

The concretization logic 311 in the concrete entity 300 is a calculation logic for calculating a value of a concrete setting item 302 from a value of an intermediate abstract setting item 252.

In the example in FIG. 14, the entity information 131 includes an abstract entity 200, “Server X”, intermediate abstract entities 250, “Server X1” and “Server X2”, concretized from the abstract entity 200 “Server X”, and concrete entities 300, “Product X11” and “Product X12”, concretized from the intermediate abstract entity 250 “Server X1”. The abstract entity 200 “Server X” includes abstract setting items 202, “A” and “B”. The intermediate abstract entity 250 “Server X1” includes intermediate abstract setting items 252, “A1” and “B1”. The concrete entity 300 “Product X11” includes concrete setting items 302, “a1” and “b1”. The intermediate abstract entity 250 “Server X1” includes a concretization logic 261, “X_X1”. The concrete entity 300 “Product X1” includes a concretization logic 311, “X1_X11”.

An operation of a program setting device 100 according to the second exemplary embodiment of the present invention will be described next.

### (Overall Process)

An overall process performed by the program setting device 100 according to the second exemplary embodiment of the present invention is similar to the process of the first exemplary embodiment of the present invention (FIG. 3), except that an input of an identifiers of an intermediate abstract entity 250 is further accepted at step S101 and that an input of a value of the intermediate abstract entity 250 can be accepted at step S104.

A user interface screens 111 according to the second exemplary embodiment of the present invention will now be described.

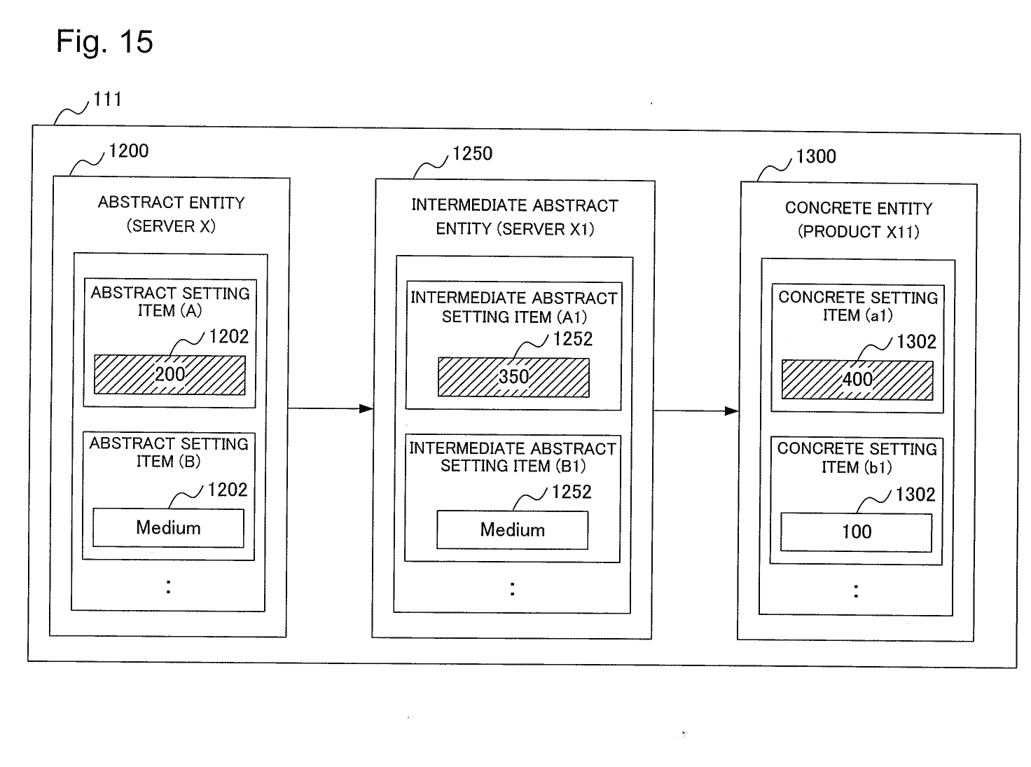

FIGS. 15, 16 and 17 are diagrams illustrating examples of the user interface screen 111 according to the second exemplary embodiment of the present invention. The exemplary user interface screens 111 correspond to the entity information 131 in FIG. 14.

Referring to FIG. 15, an abstract entity display section 1200 indicating an abstract entity 200, an intermediate abstract entity display section 1250 indicating an intermediate abstract entity 250 concretized from the abstract entity 200, and a concrete entity display section 1300 indicating a concrete entity 300 concretized from the intermediate abstract entity 250 are associated with one another and arranged in a user interface screen 111.

In the intermediate abstract entity display section 1250, as in the abstract entity display section 1200, an input field 1252 for allowing a user to input a value of each of the intermediate abstract setting items 252 included in an intermediate abstract setting item group 251 is provided. A value input in the input field 1252 is set as a user input value 254 of the intermediate abstract setting item 252 by a set value determination unit 120.

### (Set Value Determination Process)

A set value determination process performed by a program setting device 100 according to the second exemplary embodiment of the present invention will be described below.

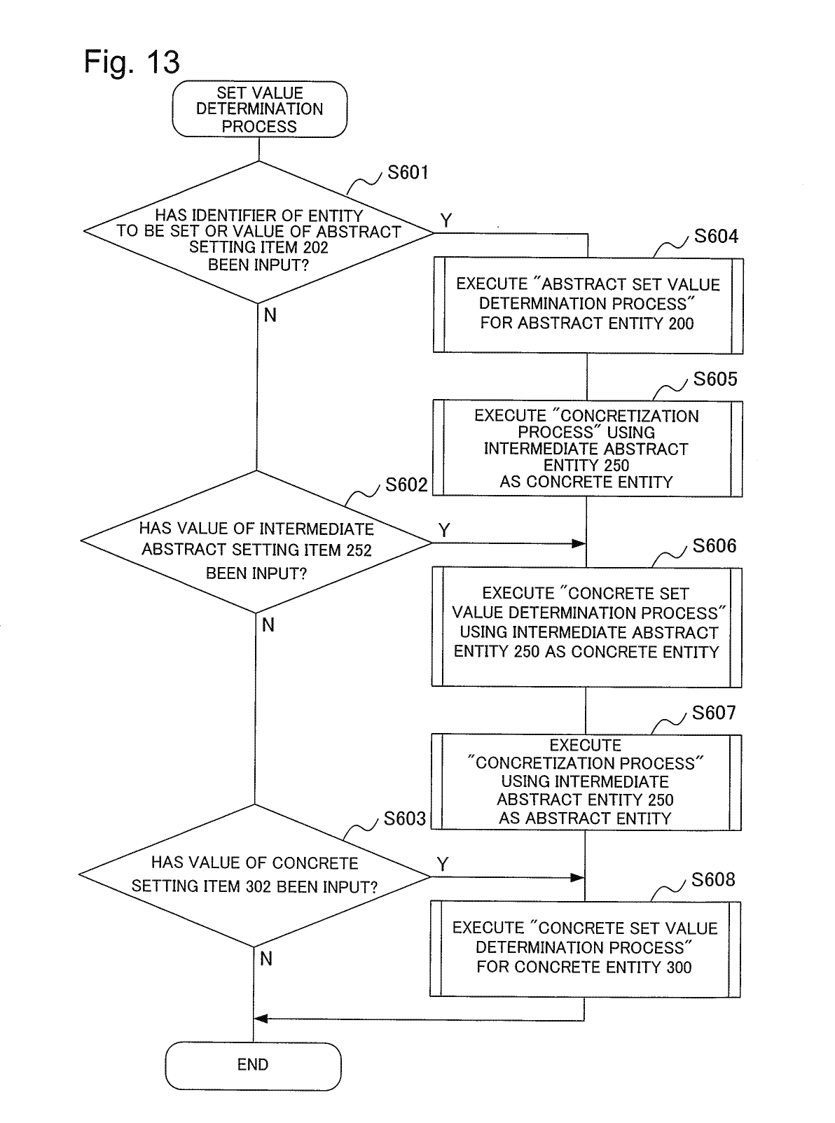

FIG. 13 is a flowchart illustrating a set value determination process performed by the program setting device 100 according to the second exemplary embodiment of the present invention.

When identifiers of entities to be set have been input at step S101 described previously or when a value of an abstract setting item 202 has been input at step S104 (Y at step S601), the set value determination unit 120 executes an “abstract set value determination process” to determine a set value 206 of the abstract setting item 202 (step S604). The set value determination unit 120 then uses an intermediate abstract entity 250 instead of a concrete entity 300 to execute a “concretization process” to calculates a calculated value 255 of an intermediate abstract setting item 252 (step S605). Furthermore, the set value determination unit 120 uses the intermediate abstract entity 250 instead of the concrete entity 300 to execute a “concrete set value determination process” to determine a set value 256 of the intermediate abstract setting item 252 (step S606). The set value determination unit 120 then uses the intermediate abstract entity 250 instead of the abstract entity 200 to execute a “concretization process” to calculate a calculated value 305 of a concrete setting item 302 (step S607). The set value determination unit 120 then executes a “concrete set value determination process” to determine a set value 306 of the concrete setting item 302 (step S608).

If a value of an intermediate abstract setting item 252 has been input at step S104 described above (Y at step S602), the set value determination unit 120 executes step S606 through step S608 to determine a set value 256 of the intermediate abstract setting item 252 and a set value 306 of the concrete setting item 302.

If a value of a concrete setting item 302 has been input at step S104 described above (Y at step S603), the set value determination unit 120 executes step S608 to determine a set value 306 of the concrete setting item 302.

For example, assume that in the entity information 131 in FIG. 14, “100” is set as the default value 203 of the abstract setting item 202 “A” of the abstract entity 200 “Server X” and “100” is set as the default value 253 of the intermediate abstract setting item 252 “A1” of the intermediate abstract entity 250 “Server X1”. In addition, it is assumed that a user has input the identifier “Server X” of the abstract entity 200, the identifier “Server X1” of the intermediate abstract entity 250, and the identifier “Product X11” of the concrete entity 300 as entities to be set.

If the user inputs a value, “200”, in the input field 1202 of the abstract setting item 202 “A”, the set value determination unit 120 sets the user input value 204 (“200”) as the set value 206 of the abstract setting item 202 “A” in an “abstract set value setting process”. Then the concretization logic execution unit 121 uses the concretization logic 261 “X_X1” to calculates a value, “350”, of the intermediate abstract setting item 252 “A1” from the set value 206, and sets the value “350” as the calculated value 255 in a “concretization process”. Furthermore, the set value determination unit 120 sets the calculated value (“350”) as the set value 256 of the intermediate abstract setting item 252 “A1” in a “concrete set value determination process”. Then the concretization logic execution unit 121 uses the concretization logic 311 “X1_X11” to calculate a value, “400”, of the concrete setting item 302 “a1” from the set value 256, and sets the value “400” as the calculated value 305 in the “concretization process”. Furthermore, the set value determination unit 120 sets the calculated value 305 (“400”) as the set value 306 of the concrete setting item 302 “a1” in the “concrete set value determination process”. In this case, an input and output unit 110 outputs a user interface screen 111 in which the set value 206 (“200”) is displayed in the input field 1202 of the abstract setting item 202 “A”, the set value 256 (“350”) is displayed in the input field 1252 of the intermediate abstract setting item 252 “A1”, and the set value 306 (“400”) is displayed in the input field 1302 of the concrete setting item 302 “a1” as depicted in FIG. 15.

Note that the input and output unit 110 may indicate, in the user interface screen 111, the updated (determined) abstract setting item 202, intermediate abstract setting item 252, and concrete setting item 302 and their set values 206, 256, 306 to the user by changing the colors of or otherwise highlighting the input fields 1202, 1252, 1302 of the abstract setting item 202, the intermediate abstract setting item 252 and the concrete setting item 302 for which the set values 206, 256, 306 have been updated (determined) as illustrated in FIG. 15.

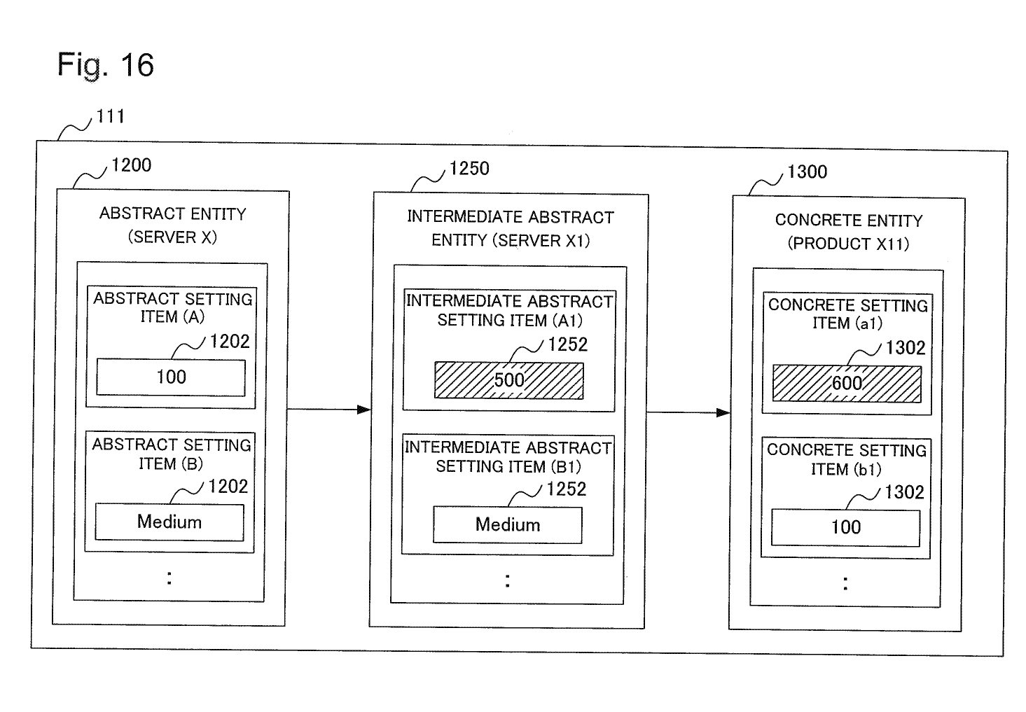

If the user inputs a value, “500”, in the input field 1252 of the intermediate abstract setting item 252 “A1”, the set value determination unit 120 sets the user input value 254 (“500”) as the set value 256 of the intermediate abstract setting item 252 “A1” in the “concrete set value determination process”. Then the concretization logic execution unit 121 uses the concretization logic 311 “X1_X11” to calculate a value, “600”, of the concrete setting item 302 “a1” from the set value 256, and sets the value “600” as the calculated value 305 of the concrete setting item 302 “a1” in the “concretization process”. Furthermore, the set value determination unit 120 sets the calculated value 305 (“600”) as the set value 306 of the concrete setting item 302 “a1” in the “concrete set value determination process”. In this case, the input and output unit 110 outputs a user interface screen 111 in which the set value 256 (“500”) is displayed in the input field 1252 of the intermediate abstract setting item 252 “A1” and the set value 306 (“600”) is displayed in the input field 1302 of the concrete setting item 302 “a1” as depicted in FIG. 16.

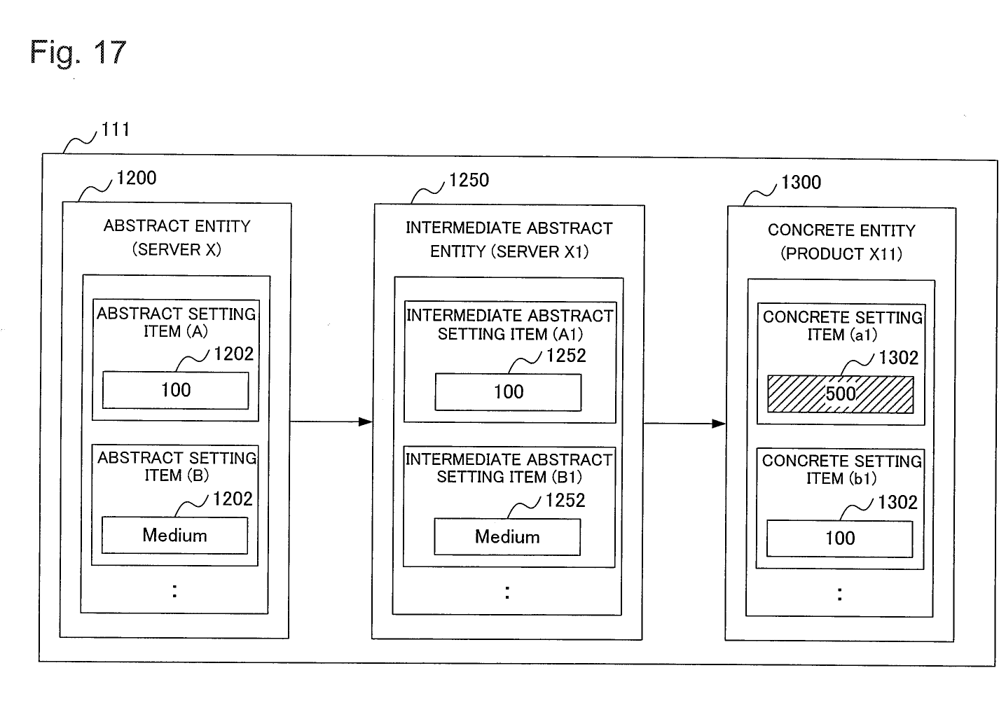

If the user inputs a value, “500”, in the input field 1302 of the concrete setting item 302 “a1”, the set value determination unit 120 sets the user input value “304” (“500”) as the set value 306 of the concrete setting item 302 “a1” in the “concrete set value determination process”. In this case, the input and output unit 110 outputs a user interface screen 111 in which the set value 306 (“500”) is displayed in the input field 1302 of the concrete setting item 302 “a1” as depicted in FIG. 17.

With this, the operation of the second exemplary embodiment of the present invention is completed.

Note that, while the operation of the second exemplary embodiment of the present invention has been described with an example in which one intermediate abstract entity 250 is defined between an abstract entity 200 and a concrete entity 300, a plurality of intermediate abstract entities 250 may be defined between an abstract entity 200 and a concrete entity 300 by repetitions of an upper-level intermediate abstract entity and a lower-level intermediate abstract entity concretized from the upper-level intermediate abstract entity (defined by nesting of a plurality of intermediate abstract entities 250). In this case, the set value determination unit 120 uses the upper-level intermediate abstract entity instead of the abstract entity 200 and the lower-level intermediate abstract entity instead of the concrete entity 300 to execute the “concretization process” to calculate a calculated value of a setting item of the lower-level intermediate abstract entity (a lower-level intermediate abstract setting item) from a setting item of the upper-level intermediate abstract entity (an upper-level intermediate abstract setting item). Furthermore, the set value determination unit 120 uses the lower-level intermediate abstract entity instead of the concrete entity 300 to execute the “concrete set value determination process” to determine a set value of the lower-level intermediate abstract setting item. The set value determination unit 120 repeats the processing to determine a set value of each intermediate abstract setting item.

Advantageous effects of the second exemplary embodiment of the present invention will be described below.

The second exemplary embodiment of the present invention can provide various setting interfaces through which a user can readily make settings for a system that has more complicated setting items than those in the first exemplary embodiment of the present invention. This is because an intermediate abstract entity 250 is further defined between an abstract entity 200 and a concrete entity 300, and the set value determination unit 120 causes the concretization logic execution unit 121 to use a concretization logic 261 to calculate a value of an intermediate abstract setting item 252 from a set value 206 of an abstract setting item 202 and to use a concretization logic 311 to calculate a value of a concrete setting item 302 from a set value 256 of the intermediate abstract setting item 252.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese Patent Application No. 2012-253443, filed on Nov. 19, 2012, the disclosure of which is incorporated herein in its entirety by reference.

### REFERENCE SIGNS LIST

100 Program setting device
110 Input and output unit
111 User interface screen
120 Set value determination unit
121 Concretization logic execution unit
130 Entity information storage unit
131 Entity information
200 Abstract entity
201 Abstract setting item group
202 Abstract setting item
203 Default value
204 User input value
206 Set value
1200 Abstract entity display section
1202 Input field
250 Intermediate abstract entity
251 Intermediate abstract setting item group
252 Intermediate abstract setting item
253 Default value
254 User input value
255 Calculated value
256 Set value
261 Concretization logic
1250 Intermediate abstract entity display section
1252 Input field
300 Concrete entity
301 Concrete setting item group
302 Concrete setting item
303 Default value
304 User input value
305 Calculated value
306 Set value
311 Concretization logic
1300 Concrete entity display section
1302 Input field

What is claimed is:

1. A program setting device comprising:
a concretization logic execution unit which executes a concretization logic for calculating a concrete setting item which is a setting item specific to each of a plurality of implementations of a program from an abstract setting item which is a setting item common to the plurality of implementations of the program, the concretization logic being defined for each of the plurality of implementations; and
a set value determination unit which, when a value of the abstract setting item is input, causes the concretization logic execution unit to calculate a value of the concrete setting item relating to an implementation to be set from an input value of the abstract setting item by using the concretization logic for the implementation to be set, and determines the calculated value as a set value of the concrete setting item.

2. The program setting device according to claim 1, further comprising an input and output unit which outputs a user interface screen which displays the abstract setting item and the concrete setting item relating to the implementation to be set in association with each other, accepts an input of a value of the abstract setting item, and indicates the concrete setting item relating to the implementation to be set, for which a set value has been determined by the set value determination unit, and the set value of the concrete setting item.

3. The program setting device according to claim 1, wherein,
when a value of the concrete setting item is input, the set value determination unit determines the input value of the concrete setting item as the set value of the concrete setting item in priority to a calculated value of the concrete setting item.

4. The program setting device according to claim 1, wherein,
when no value for the abstract setting item is input, the set value determination unit causes the concretization logic execution unit to calculate a value of the concrete setting item relating to the implementation to be set from a predetermined initial value of the abstract setting item, and
when no value for the concrete setting item is input and no calculated value exists for the concrete setting item, the set value determination unit determines a predetermined initial value of the concrete setting item as the set value of the concrete setting item.

5. The program setting device according to claim 1, wherein,
when an intermediate abstract setting item which is a setting item common to a set of one or more implementations out of the plurality of implementations of the program is defined, the set value determination unit causes the concretization logic execution unit to calculate a value of the intermediate abstract setting item relating to a set including an implementation to be set from the value of the abstract setting item by using the concretization logic for the set including the implementation to be set, determines the calculated value as the set value of the intermediate abstract setting item, and causes the concretization logic execution unit to calculate a value of the concrete setting item relating to the implementation to be set from the set value of the intermediate abstract setting item by using the concretization logic for the implementation to be set.

6. The program setting device according to claim 5, further comprising an input and output unit which outputs a user interface screen which displays the abstract setting item, the intermediate abstract setting item relating to the set including the implementation to be set, and the concrete setting item relating to the implementation to be set in association with one another, accepts an input of a value of the abstract setting item, indicates the intermediate abstract setting item relating to the set including the implementation to be set, for which a set value has been determined by the set value determination unit, and the set value of the intermediate abstract setting item, and indicates the concrete setting item relating to the implementation to be set, for which a set value has been determined by the set value determination unit, and the set value of the concrete setting item.

7. The program setting device according to claim 5, wherein,
when a value of the intermediate abstract setting item is input, the set value determination unit determines the input value of the intermediate abstract setting item as the set value of the intermediate abstract setting item in priority to a calculated value of the intermediate abstract setting item, and
when a value of the concrete setting item is input, the set value determination unit determines the input value of the concrete setting item as the set value of the concrete setting item in priority to a calculated value of the concrete setting item.

8. A program setting method comprising:
when a value of an abstract setting item which is a setting item common to a plurality of implementations of a program is input,
calculating, by using a concretization logic for an implementation to be set out of concretization logics for calculating a concrete setting item which is a setting item specific to each of the plurality of implementations of the program from the abstract setting item, a value of the concrete setting item relating to the implementation to be set from an input value of the abstract setting item, the concretization logic being defined for each of the plurality of implementations; and
determining the calculated value as a set value of the concrete setting item.

9. The program setting method according to claim 8, further comprising outputting a user interface screen which displays the abstract setting item and the concrete setting item relating to the implementation to be set in association with each other, accepts an input of a value of the abstract setting item, and indicates the concrete setting item relating to the implementation to be set, for which a set value has been determined, and the set value of the concrete setting item.

10. A non-transitory computer readable storage medium recording thereon a program causing a computer to perform a method comprising:
when a value of an abstract setting item which is a setting item common to a plurality of implementations of a program is input,
calculating, by using a concretization logic for an implementation to be set out of concretization logics for calculating a concrete setting item which is a setting item specific to each of the plurality of implementations of the program from the abstract setting item, a value of the concrete setting item relating to the implementation to be set from an input value of the abstract setting item, the concretization logic being defined for each of the plurality of implementations; and
determining the calculated value as a set value of the concrete setting item.

11. A program setting device comprising:
a concretization logic execution means for executing a concretization logic for calculating a concrete setting item which is a setting item specific to each of a plurality of implementations of a program from an abstract setting item which is a setting item common to the plurality of implementations of the program, the concretization logic being defined for each of the plurality of implementations; and
a set value determination means for, when a value of the abstract setting item is input, causing the concretization logic execution means to calculate a value of the concrete setting item relating to an implementation to be set from an input value of the abstract setting item by using the concretization logic for the implementation to be set, and determining the calculated value as a set value of the concrete setting item.
